(19) United States
(12) Patent Application Publication
(10) Pub. No.: US 2009/0296404 A1
(43) Pub. Date: Dec. 3, 2009

(54) Universal mount lighting fixture

(76) Inventor: Kevin Yang, Palos Verdes Est., CA (US)

Correspondence Address: LAW OFFICES OF CLEMENT CHENG, 17220 NEWHOPE STREET #127, FOUNTAIN VALLEY, CA, 92708, US

(21) Appl. No.: 12/387,362

(22) Filed: May 1, 2009

Related U.S. Application Data
(63) Continuation-in-part of application No. 12/154,894, filed on May 28, 2008.

(51) Int. Cl. F21V 7/00

(52) U.S. Cl. 362/296.01

(57) ABSTRACT

A universal mount lighting fixture comprises a housing having a rectangular profile with a ballast channel disposed in a top surface of the housing. The ballast channel extends across the length of the housing. A pair of ballast wire openings are disposed on a surface of the housing. A reflector is mounted within the housing. A ballast is mounted to an exterior surface of the housing. The ballast has two opposite edgewise basins with access openings for power wires to input and output connectors. The ballast can be mounted within the ballast channel and the pair of ballast wire openings can be disposed in a horizontal portion of the ballast channel. The channel can be flared. The ballast can be mounted on an end or side of the housing.

This application is a continuation in part of U.S. patent application Ser. No. 12/154,894 filed May 28, 2008 entitled Ballast with Multi-lead Wires, the disclosure of which is incorporated herein in its entirety by reference.

### BACKGROUND OF THE INVENTION

A. Field of the Invention

The present invention relates to lighting fixtures.

B. Description of the Prior Art

As seen in FIGS. 1-4, the prior art florescent lighting fixture generally includes a ballast 20 mounted in a fixture housing 25. The fixture has a reflector 30 and a plurality of bulbs 35 mounted in sockets 40. The prior art florescent lighting fixture housing 25 typically has a ballast compartment above the reflector 30.

### SUMMARY OF THE INVENTION

The present invention is an alternate construction for a lighting fixture which has a universal mount for the ballast. The present invention uses an external mounting for a ballast. The ballast can be mounted in a slot formed on an upper surface of the housing. Alternatively, the ballast can be mounted on a front edge wall of the housing or on a side edge wall of the housing. Having multiple locations for mounting a ballast provides flexibility during installation.

The ballast is typically an elongated rectangular box having a pair of openings. A ballast with multi-lead wires has been described previously in U.S. patent application Ser. No. 12/154,894 filed May 28, 2008 entitled Ballast with Multi-lead Wires, the disclosure of which is incorporated herein in its entirety by reference.

A ballast with multilateral lead wires is provided according to the present invention for supplying a power for energizing fluorescent lamps. The ballast comprises (a) a longitudinal container with five sided walls and an opening for containing a ballast circuit for processing an input power and generating a lamp power supply to one or more of the lamps, the circuit including an input connector mounted on an edge of the circuit for receiving input power wires and an output connector mounted on the opposite edge of the circuit from the input connector for connecting one or more sets of output lead wires; (b) a lid having four sided walls sized to tightly fastened over the container and a top wall having two opposite edgewise basins with access openings for the wires to the input and output connectors; and (c) two opposite brackets formed integral to the lid next to the basins for fastening the ballast to a lamp fixture. Therefore, the lid permits the input power wires and output lead wires to enter the input connector and output connector, respectively from a common longitudinal plane lower than the level of the lid as well as in a perpendicular direction with respect to the longitudinal plane as determined by the positions of receiving ends of the ballast wires in the lamp fixture.

The ballast may also have an interlocking means between the container and lid for permanently fastening them together. The interlocking means may include a couple of smaller depressions with inward longitudinal edges formed on two opposing side walls of the lid, a couple of push tabs defined by crescent slots formed on the same side walls, larger depressions with downward longitudinal edges formed on the walls of the container for receiving the lid depressions so that they interlock by the inward edges engaging the downward edges as the lid is pressed onto the container, and tab holes formed on the walls of the base for holding the push tabs of the lid when they are crimped inwardly of the ballast through the tab holes to establish a permanent assembly of the ballast.

The ballast further comprises bushings shaped to fit tightly into and over the basins of the lid for protecting the wires from an abrasive injury, each of the bushings having a short tubular body with multiple lengthwise protrusions for engaging inner diameters of the access openings of the basins and a top shoulder surrounding the tubular body to keep the bushings rest on the access openings and wherein the basins are contoured smoothly to merge with the general surface of the lid to provide a smooth surrounding for the wires to contact.

The objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a cross section view of a prior art fixture.

FIG. 2 is a lower perspective view of a prior art fixture.

FIG. 3 is a perspective cut away view of a prior art fixture.

FIG. 4 is a perspective exploded view of a prior art fixture.

FIG. 5 is a cross section view of the present invention.

FIG. 6 is a lower perspective view of the present invention.

FIG. 7 is a perspective cut away view of the present invention.

FIG. 8 is an exploded view of the present invention.

FIG. 9 is a perspective view of the present invention with an end mounted ballast.

FIG. 10 is a cut away view of the present invention with an end mounted ballast.

FIG. 11 is an exploded view of the present invention with an end mounted ballast.

FIG. 12 is a perspective view of the present invention with a side mounted ballast.

FIG. 13 is a cut away view of the present invention with a side mounted ballast.

FIG. 14 is an exploded view of the present invention with a side mounted ballast.

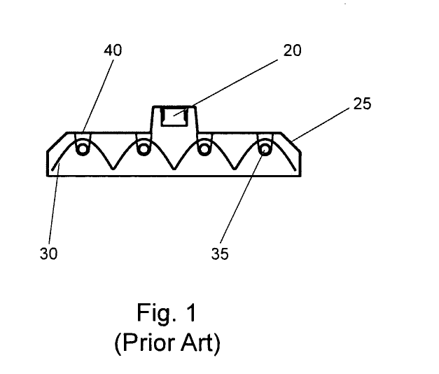

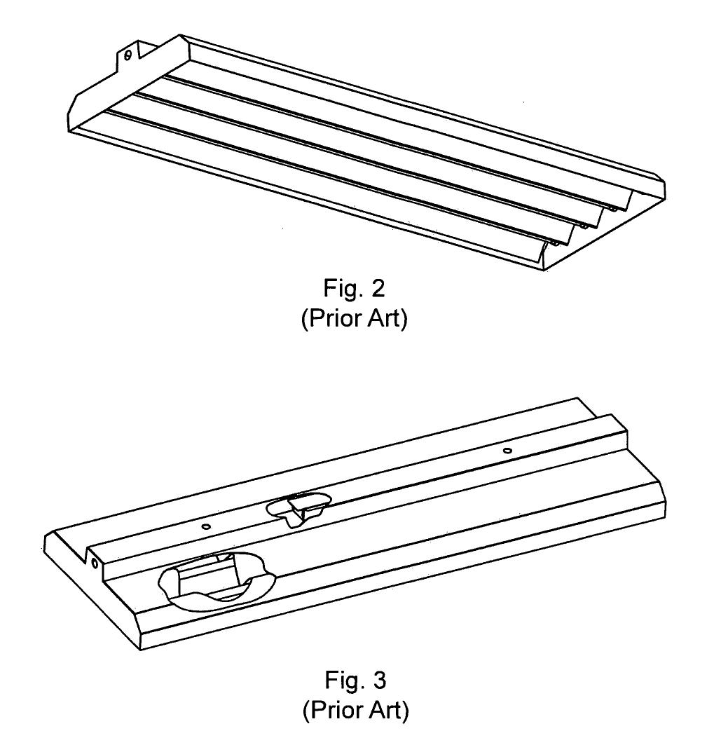

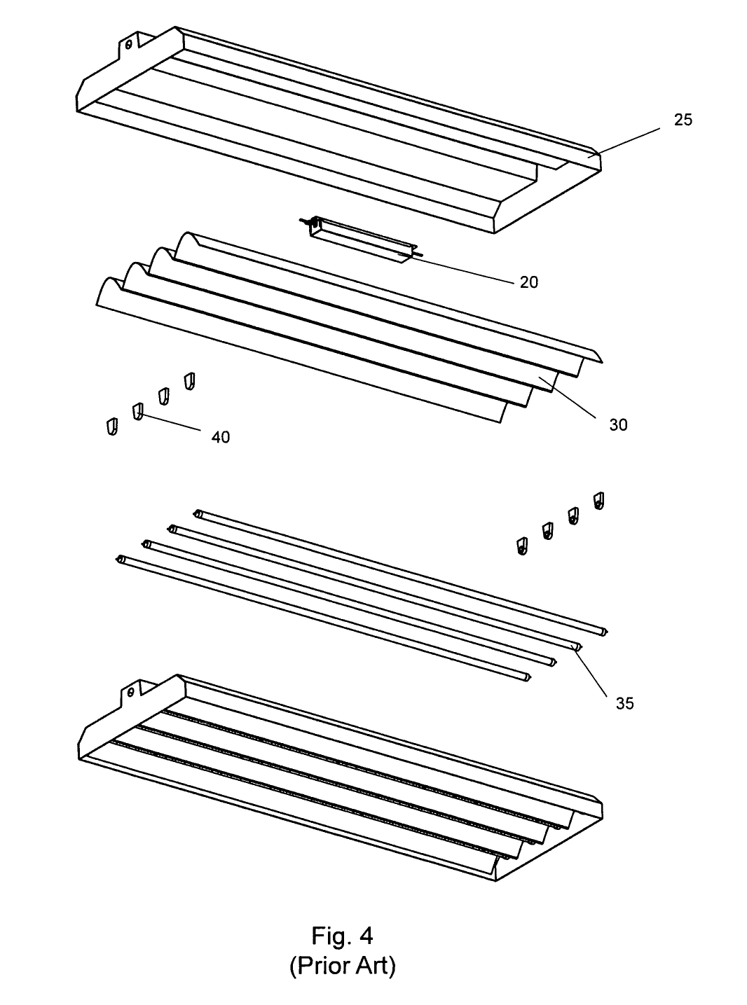

Similar reference numbers denote corresponding features throughout the attached drawings.
20 ballast
25 housing
30 reflector
35 bulb
40 socket

### DETAILED DESCRIPTION OF THE PREFERRED EMBODIMENT

A florescent light fixture can use a ballast with multilateral lead wires. The ballast allows lead wires to pass downward from a bottom surface of the ballast as well as from the sides of the ballast at each end of the ballast. The housing has a slot shaped ballast channel receiving the ballast at an upper surface of the housing. The channel has a horizontal portion and a pair of channel sidewalls. The channel sidewalls can be flared to provide a gap between the ballast and the upper surface of the housing. The flared channel introduces a gap which increases toward the top of the channel, and is approximately enough to retain the width of the ballast at a lower portion of the channel. The channel can extend to the edge of the end of the housing of the fixture.

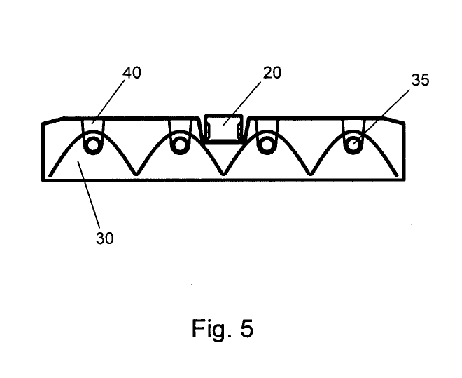

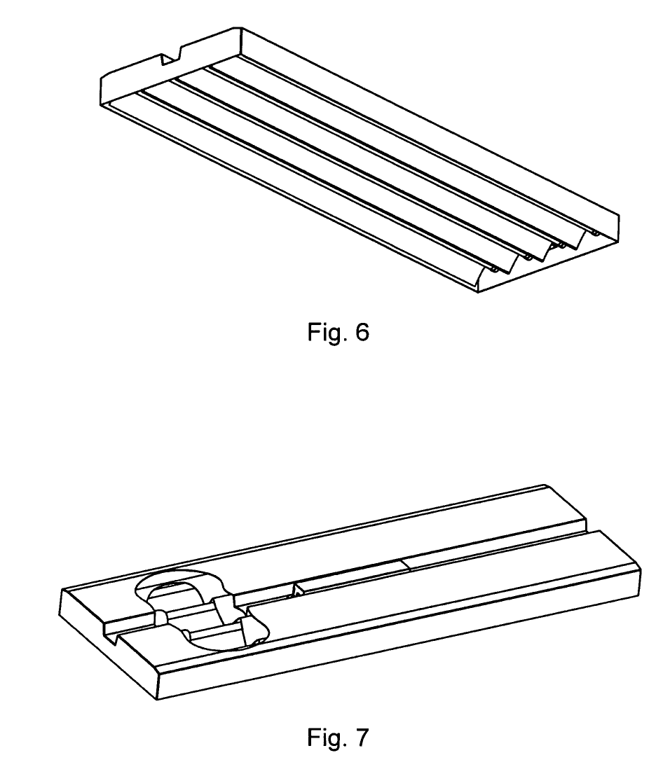

The housing is shown as rectangular in FIGS. 5-8. A reflector made from a sheet of reflective material provides reflection of light away from the fixture. The reflector fits fully within the rectangular profile of the housing and provides for enough space for four fluorescent tubes. The ballast also fits within the rectangular profile of the housing, between the reflectors. The ballast can be secured in place by screws extending through flat extending tabs disposed at each end of the ballast.

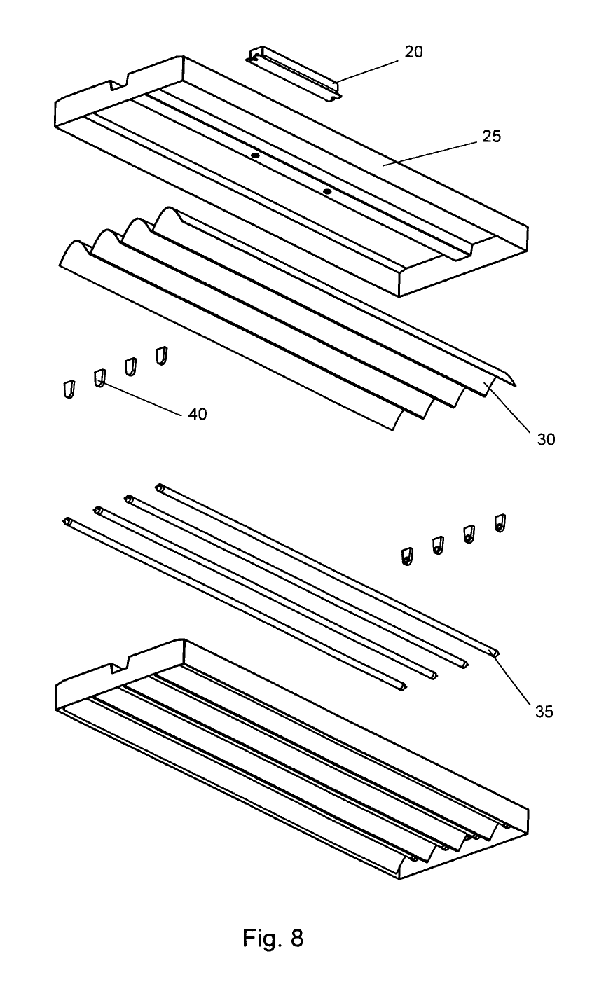

The channel in the top surface of the housing is made from bending or rolling a channel lengthwise into the top surface of the housing. The slot shaped channel can receive the ballast along any position of the channel. A pair of openings FIG. 8 can be knocked out from pre-perforated openings disposed along the length of the channel. The pair of openings provides wire ingress from the ballast 20 the interior of the housing 25. When the ballast is installed within the channel, the open air of the channel provides natural convection for cooling the ballast. The ballast can be electronic or magnetic.

The other elements, namely the sockets and bulbs can be installed after the reflector is installed. The ballast, FIG. 8, has two opposite edgewise basins with access openings for power wires to input and output connectors.

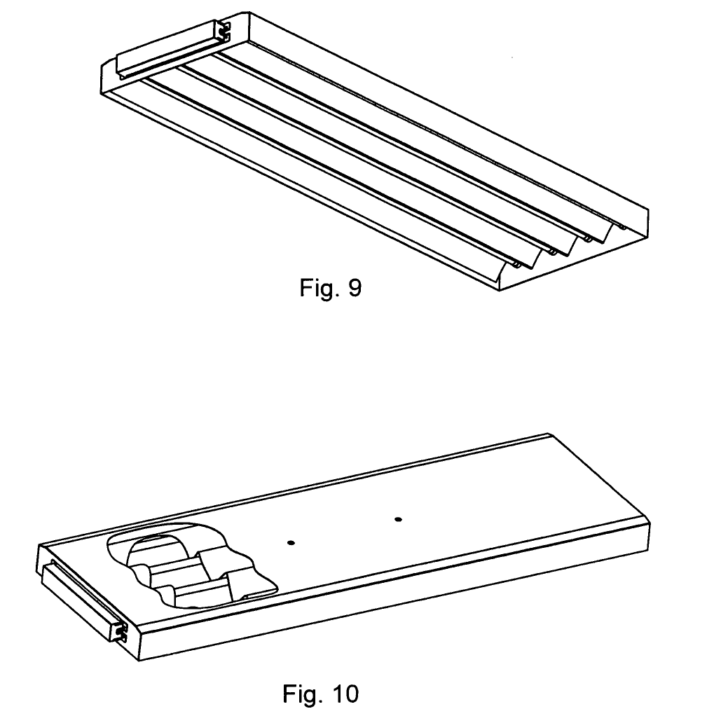

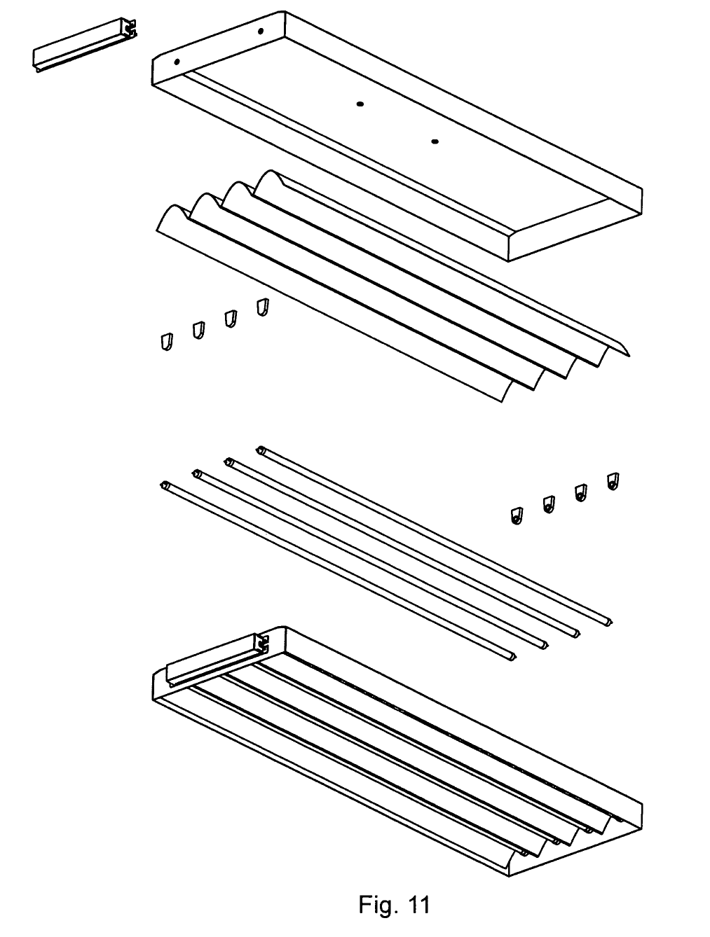

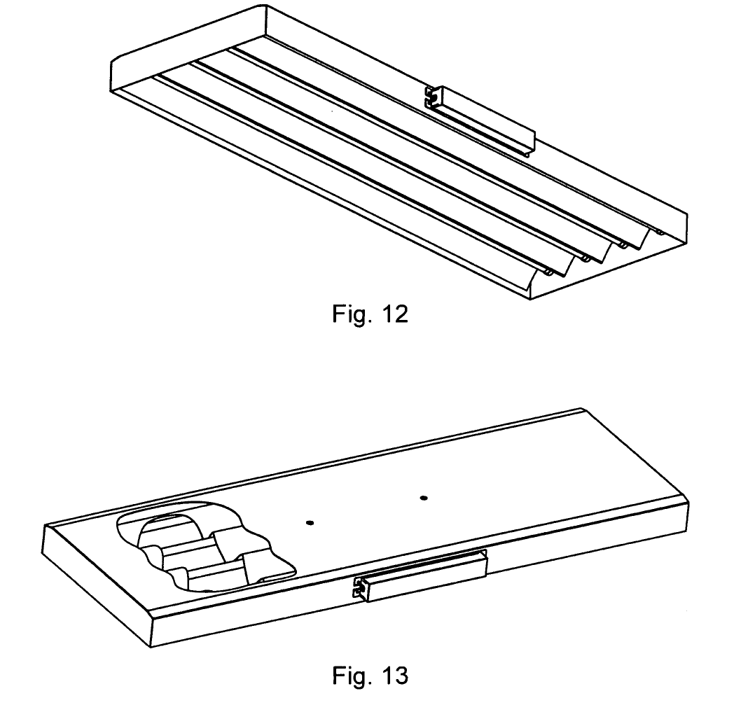

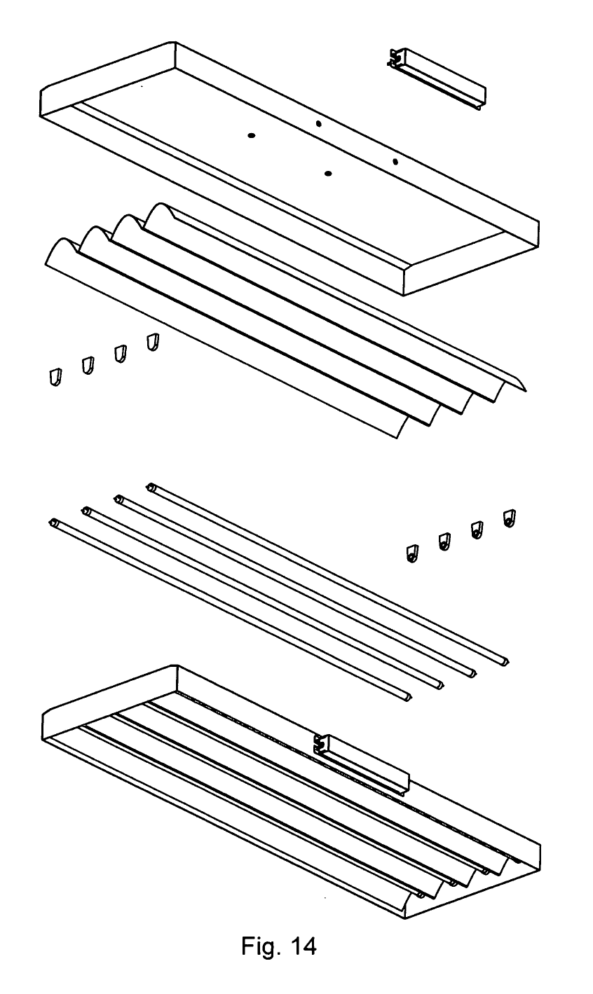

In alternate embodiments, the ballast can be installed on the outside of the housing at an end of the housing on the sidewall FIGS. 9-11. The ballast can also be installed on a side of the housing FIGS. 12-14 on the sidewall.

Therefore, while the presently preferred form has been shown and described, it is to be understood that the present invention is not limited to the sole embodiment described above, but encompasses any and all embodiments within the scope of the following claims.

1. A universal mount lighting fixture comprising:
a. a housing having a rectangular profile;
b. a ballast channel disposed in a top surface of the housing, wherein the ballast channel extends across the length of the housing;
c. a pair of ballast wire openings disposed on a surface of the housing;
d. a reflector mounted within the housing;
e. a ballast mounted to an exterior surface of the housing, wherein the ballast has two opposite edgewise basins with access openings for power wires to input and output connectors.

2. The universal mount lighting fixture of claim 1, wherein the ballast is mounted within the ballast channel, wherein the pair of ballast wire openings are disposed in a horizontal portion of the ballast channel.

3. The universal mount lighting fixture of claim 2, wherein the channel is flared.

4. The universal mount lighting fixture of claim 1, wherein the ballast is mounted on an end of the housing on a sidewall, wherein the pair of ballast wire openings are disposed on the end of the housing on the sidewall.

5. The universal mount lighting fixture of claim 1, wherein the ballast is mounted on a side of the housing on a sidewall, wherein the pair of ballast wire openings are disposed on the side of the housing on the sidewall.
